(19) United States
(12) Patent Application Publication
(10) Pub. No.: US 2017/0062151 A1
(43) Pub. Date: Mar. 2, 2017

(54) KEY SWITCH

(71) Applicant: KABUSHIKI KAISHA TOSHIBA, Tokyo (JP)

(72) Inventor: Kageyuki ISO, Taipei (TW)

(21) Appl. No.: 15/019,787

(22) Filed: Feb. 9, 2016

Related U.S. Application Data
(60) Provisional application No. 62/211,643, filed on Aug. 28, 2015.

(51) Int. Cl. H01H 13/14; H01H 13/52; H01H 13/10

(52) U.S. Cl. CPC H01H 13/14; H01H 13/10; H01H 13/52

(57) ABSTRACT

According to one embodiment, a key switch includes a base member, a keycap, a supporting member, and a membrane switch. At least one of the keycap and the supporting member includes a projection portion pressing the membrane switch when the keycap descends. The membrane switch includes a flexible portion bending as being pressed by the projection portion. The base member includes an opening portion which the flexible portion pressed and bent by the projection portion enters.

### CROSS-REFERENCE TO RELATED APPLICATIONS

This application claims the benefit of U.S. Provisional Application No. 62/211,643, filed Aug. 28, 2015, the entire contents of which are incorporated herein by reference.

### FIELD

Embodiments described herein relate generally to a key switch.

### BACKGROUND

To achieve size and weight reduction of electronic devices such as notebook computers, keyboards have been made thinner. For example, in the thickness reduction of a keyboard comprising a number of key switches with which the operators perform keystrokes, it is necessary to ensure the stroke of each key switch while reducing the total height in a non-operating state as well as in a keystroke operation state.

In the keystroke operation of the key switch, there are some cases where the keycap strikes the base member of the keyboard or the like and makes a sound when reaching its lowermost position. According to the structure which allows the keycap to strike the member, the lowermost position of the keycap is easily determined, and consequently the total height of the key switch can be easily reduced. Therefore, in light of the thickness reduction of the keyboard, it is not preferable to have a structure which prevents the keycap to strike the member.

However, depending on use environments and the like, quiet performance is required for electronic devices. Therefore, there is also demand for a technique of reducing the striking sound produced in the keystroke operation of the key switch.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary right side view of a key switch of an embodiment.

FIG. 2 is an exemplary top plan view of a base member of the key switch of FIG. 1.

FIG. 3 is an exemplary top plan view of a keycap of the key switch of FIG. 1.

FIG. 4 is an exemplary top plan view of a supporting member (first supporting member) of the key switch of FIG. 1.

FIG. 5 is an exemplary top plan view of another supporting member (second supporting member) of the key switch of FIG. 1.

FIG. 6 is an exemplary top plan view of a membrane switch of the key switch of FIG. 1.

FIG. 7 is an exemplary sectional view of the membrane switch of the key switch of FIG. 1 in a normal state.

FIG. 8 is an exemplary sectional view of the membrane switch of the key switch of FIG. 1 in an elastic deformation state.

FIG. 9 is an exemplary diagram briefly showing a state where the keycap of the key switch of FIG. 1 is at the lowermost position.

FIG. 10 is an exemplary diagram showing a modified example in which a projection portion provided in a supporting member attachment portion contacts a flexible portion of the membrane switch.

FIG. 11 is an exemplary diagram showing another modified example in which a projection portion provided in a connecting member attachment portion contacts a flexible portion of the membrane switch.

### DETAILED DESCRIPTION

Various embodiments will be described hereinafter with reference to the accompanying drawings.

In general, according to one embodiment, a key switch comprises: a plate-like base member; a keycap supported by the base member and configured to ascend or descend with respect to the base member; a supporting member supporting the keycap to the base member so that the keycap ascends or descends with respect to the base member; and a sheet-like membrane switch overlaid on the base member and configured to open or close contacts of circuits when the keycap ascends or descends with respect to the base member. At least one of the keycap and the supporting member comprises a projection portion that presses the membrane switch when the keycap descends with respect to the base member. The membrane switch comprises a flexible portion that bends when pressed by the projection portion. The base member comprises an opening portion that the flexible portion enters when pressed and bent by the projection portion.

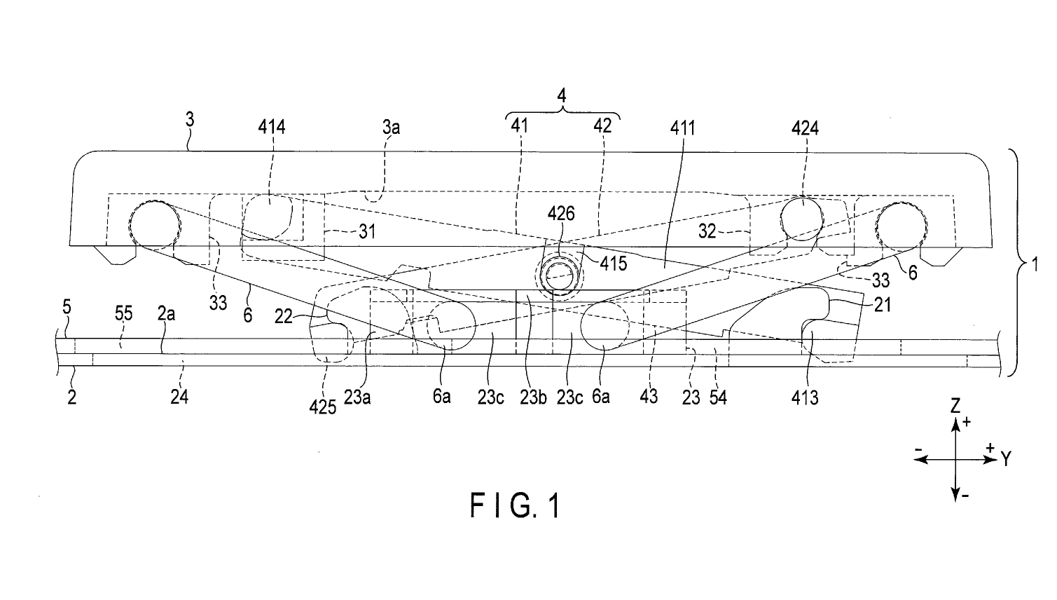

A key switch 1 of an embodiment will be described below with reference to FIGS. 1 to 9. Note that description all is given in terms of three-dimensional space specified in terms of x; y and z-axes as shown in FIGS. 1 to 6 and 9, where the x-axis is the longitudinal axis of the key switch 1, the y-axis is the lateral axis of the key switch 1, and the z-axis is the axis perpendicular to the x-y plane of the key switch 1. Here, the plus signs of the x-axis, the y-axis and the z-axis indicate the right side, the front side and the upper side of the key switch 1, respectively. Note that the above-described sides of the key switch 1 do not necessarily correspond to the sides of the key switch 1 when viewed from the operator.

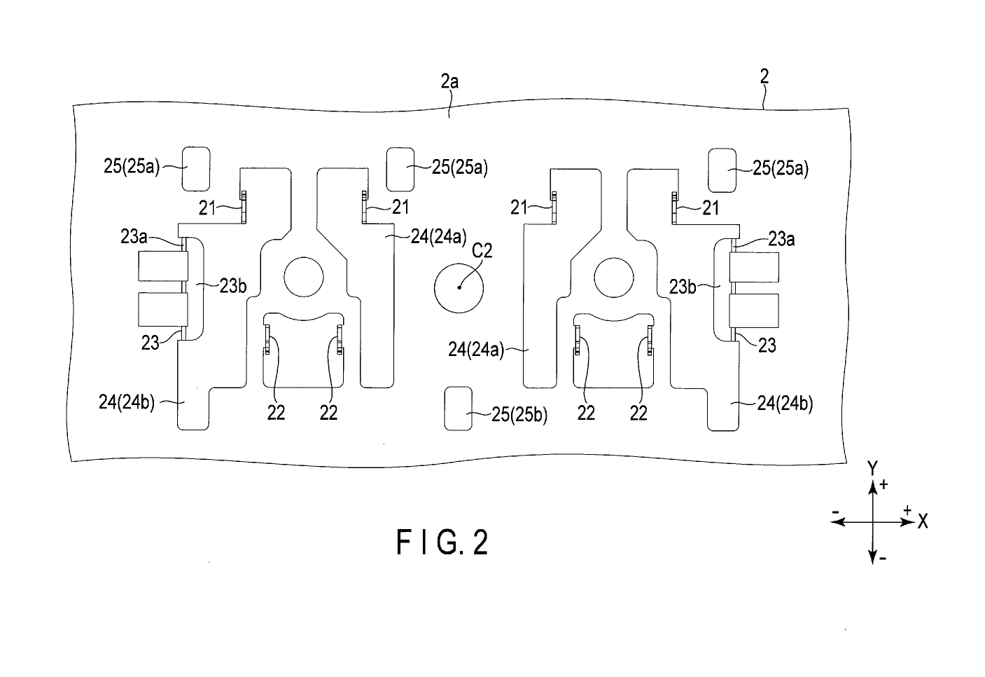

The key switch 1 is applicable to a keyboard of an electronic device such as a notebook computer. Note that the key switch 1 is not restrictedly applied to a keyboard of an electronic device but may be adapted to other uses. FIG. 1 is a right side view of the structure of the key switch 1. As shown in FIG. 1, the key switch 1 comprises a base member 2, a keycap 3, a supporting member 4 and a membrane switch 5. The membrane switch 5 is overlaid on the base member 2, and the keycap 3 supported by the supporting member 4 is provided above them. In this case, the base member 2, the membrane switch 5 and the keycap 3 are provided in this order from below in such a manner that reference points C2, C5 and C3 shown in FIGS. 2, 6 and 3 align with each other on the same axis.

FIG. 2 is a top plan view of the structure of the base member 2. The base member 2 is formed into a plate using a metal material such as an aluminum alloy, and fixed to a predetermined portion of a housing of an electronic device (not shown). On an upper surface 2a of the base member 2, a plurality of the keycaps 3 are arranged according to a predetermined standard.

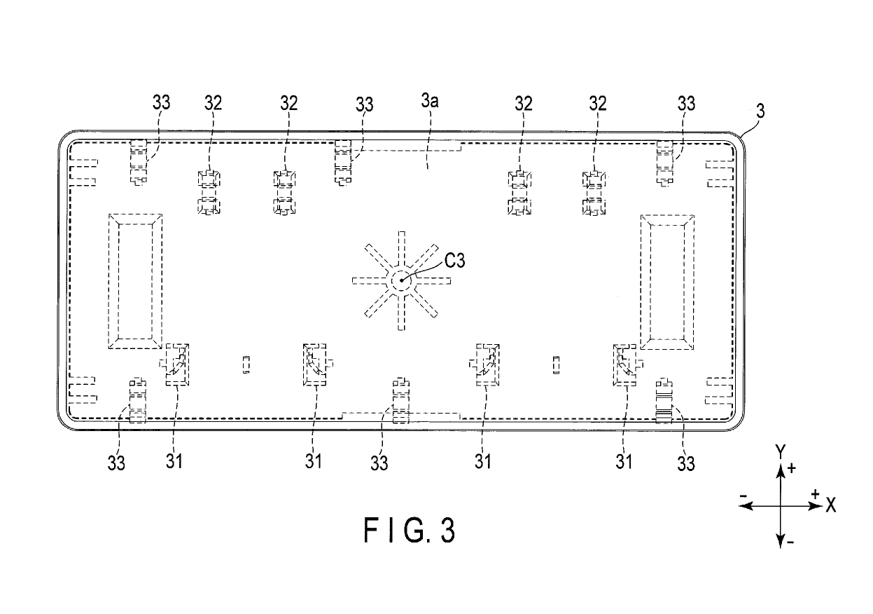

FIG. 3 is a top plan view of the structure of the keycap 3. The keycap 3 is a substantially box-shaped resin member having a size sufficiently large for the operator to make a keystroke (press down with the finger), and is provided on the upper surface 2a of the base member 2 in such a manner as that the lower surface 3a of the keycap 3 (the surface opposite to the upper surface pressed by the operator) faces the upper surface 2a. The lower surface 3a of the keycap 3 comprises a plurality of supporting member attachment portions 31 and 32 which attach the supporting members 4.

The supporting member attachment portions 31 are provided at the back of the lower surface 3a along the x-axis in pairs. On the other hand, the supporting member attachment portions 32 are provided on the front of the lower surface 3a along the x-axis in pairs. The structures of the supporting member attachment portions 31 and 32 are not restricted to any particular structures. FIG. 3 shows a case where the supporting member attachment portions 31 and 32 comprise hooks and detachably hold shafts of the supporting members 4, which will be described later, as an example. Further, FIG. 3 shows a case where two pairs each including a pair of the supporting member attachment portions 31 and a pair of the supporting member attachment portions 32 are provided on the right side and the left side of the longitudinal lower surface 3a, as an example. The number of the supporting member attachment portions 31 and 32 may be adjusted according to the number of the supporting members 4 determined on the basis of the size of the keycap 3.

Further, the upper surface 2a of the base member 2 comprises a plurality of supporting member attachment portions 21 and 22 which attach the supporting members 4 and correspond to the supporting member attachment portions 31 and 32. The supporting member attachment portions 21 are provided along the x-axis in pairs with gaps similar to those of the pairs of the supporting member attachment portions 31. On the other hand, the supporting member attachment portions 22 are provided along the x-axis in pairs with gaps similar to those of the pairs of the supporting member attachment portion 32. The supporting member attachment portion 21 and the supporting member attachment portion 31 are provided alternately along the y-axis, and the supporting member attachment portion 22 and the supporting member attachment portion 32 are provided alternately along the y-axis. By providing in this way, the supporting member attachment portions 31 and 32 are respectively connected to the supporting member attachment portions 21 and 22 by the supporting members 4. Note that, although FIG. 2 shows a case where the supporting member attachment portions 21 and 22 comprise hooks which detachably hold the shafts of the supporting members 4, which will be described later, as an example, the structures of the supporting member attachment portions 21 and 22 are not restricted to these structures. Further, the supporting member attachment portions 21 and 22 project upward from through-holes 55 of the membrane switch 5 overlaid on the base member 2, which will be described later.

Still further, the lower surface 3a of the keycap 3 comprises a connecting member attachment portion 33 which attaches a connecting member 6 connecting the keycap 3 to the base member 2. The connecting member 6 is formed of a metal bar bent in such a manner as to form a rectangle one side of which is missing, and connects the keycap 3 to the base member 2.

The connecting member attachment portion 33 comprises a hook to detachably hold the connecting member 6 and is provided along the outer edge of the lower surface 3a. FIG. 3 shows a case where six connecting member attachment portions 33 are provided one by one near the four corners of the lower surface 3a and near the middle portions of the longitudinal lower surface 3a.

Further, the upper surface 2a of the base member 2 comprises connecting member attachment portions 23 for attaching the connecting members 6 in portions corresponding to the edge portions of the longitudinal keycap 3. The connecting member attachment portion 23 comprises a standing piece 23a standing up from the base member 2 and a bent piece 23b bent from the standing piece 23a and extending in parallel to the base member 2. The standing piece 23a is provided with a through-hole 23c which an edge portion 6a of the connecting member 6 near the missing side is inserted into and engaged with.

By providing the connecting member attachment portions 33 of the keycap 3 which hold the connecting members 6 as well as the connecting member attachment portions 23 of the base member 2 which engage the connecting members 6 with the through-holes 23c, the keycap 3 can be detachably connected to the base member 2 by the connecting members 6. In this way, it is possible to prevent the keycap 3 from unintentionally dropping off from the base member 2. Note that the connecting member attachment portion 23 projects upward from the through-hole 55 of the membrane switch 5 overlaid on the base member 2, which will be described later. Further, the through-hole 23c is formed loosely to allow possible position shifts of the engaged edge portion 6a of the connecting member 6 which occur when the keycap 3 ascends or descends.

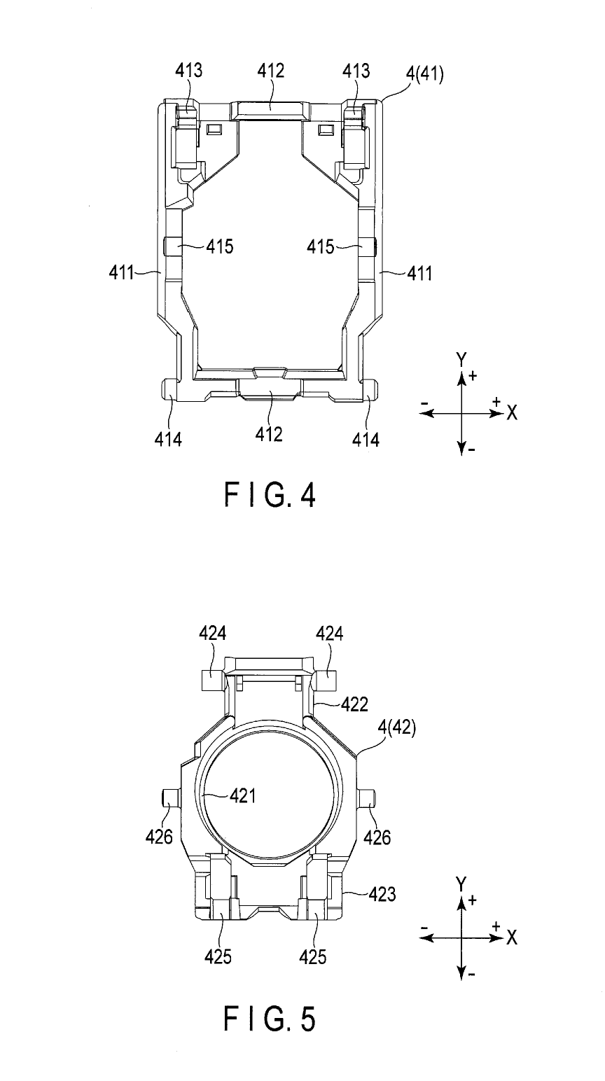

FIGS. 4 and 5 are top plan views of the structure of the supporting member. The supporting member 4 comprises a first supporting member 41 and a second supporting member 42 integrated with each other. The first supporting member 41 and the second supporting member 42 are attached to each other in such a manner as to rotate as the keycap 3 ascends or descends.

As shown in FIG. 4, the first supporting member 41 comprises a pair of arm portions 411 extending along the y-axis and a pair of bridge portions 412 between the end portions of the longitudinal arm portions 411, and has a substantially rectangular frame shape as a whole. The bridge portion 412 on the front comprises first shaft portions 413. The first shaft portions 413 are engaged with the supporting member attachment portions 21 of the base member 2 in such a manner as to slide along the y-axis. Further, the rear-end portions of the pair of the arm portions 411 are provided respectively with second shaft portions 414 symmetrically projecting outward along the x-axis. The second shaft portions 414 are rotatably engaged with the supporting member attachment portions 31 of the keycap 3. Further, the pair of arm portions 411 comprises attachment holes 415 into which attachment shafts 426 of the second supporting member 42, which will be described later, are inserted. The attachment holes 415 are formed by making dents in substantially middle portions of the pair of the longitudinal arm portions 411 from the inner side to the outer side along the x-axis in such a manner that the upper portions are open and the inner peripheries are facing outside.

As shown in FIG. 5, the second supporting member 42 comprises a ring frame portion 421, a first extension portion 422 extending forward from the ring frame portion 421, and a second extension portion 423 extending backward from the ring frame portion 421. The first extension portions 422 comprise first shaft portions 424 symmetrically projecting outward along the x-axis. The first shaft portions 424 are rotatably engaged with the supporting member attachment portions 32 of the keycap 3. Further, the second extension portions 423 comprise second shaft portions 425. The second shaft portions 425 are engaged with the supporting member attachment portions 22 of the base member 2 in such a manner as to slide along the y-axis. Still further, the middle portions of the longitudinal ring frame 421 are provided with a pair of the attachment shafts 426 symmetrically projecting outward along the x-axis. The attachment shafts 426 are rotatably inserted into the attachment holes 415 of the first supporting member 41.

As the first shaft portions 413 of the first supporting member 41 are engaged with the supporting member attachment portions 21 of the base member 2 and the second shaft portions 414 of the first supporting member 41 are engaged with the supporting member attachment portions 31 of the keycap 3, the keycap 3 is connected to the base member 2 by the first supporting member 41. Further, as the first shaft portions 424 of the second supporting member 42 are engaged with the supporting member attachment portions 32 of the keycap 3 and the second shaft portions 425 are engaged with the supporting member attachment portions 22 of the base member 2, the keycap 3 is connected to the base member 2 by the second supporting member 42. Still further, as the attachment shafts 426 of the second supporting member 42 are inserted into the attachment holes 415 of the first supporting member 41 from the upper opening portions, the first supporting member 41 and the second supporting member 42 are attached to each other in such a manner that the first supporting member 41 and the second supporting member 42 can ascend or descend while rotating in directions opposite to each other at the center of the attachment shafts 426. In this way, the first supporting member 41 and the second supporting member 42 support the keycap 3 in such a manner that the keycap 3 can ascend or descend.

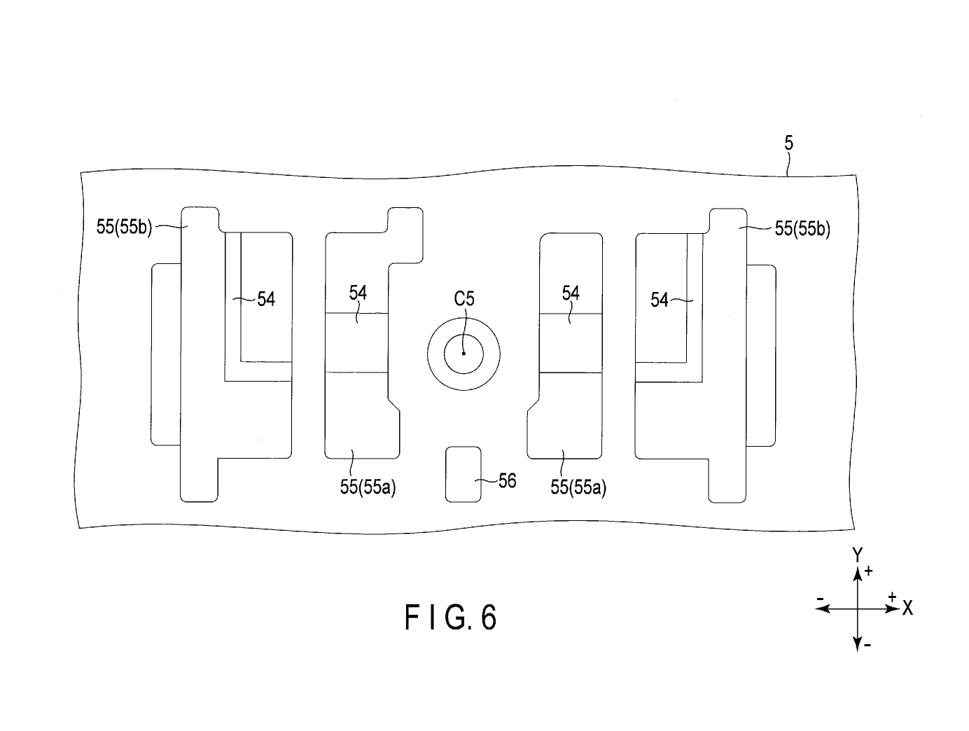

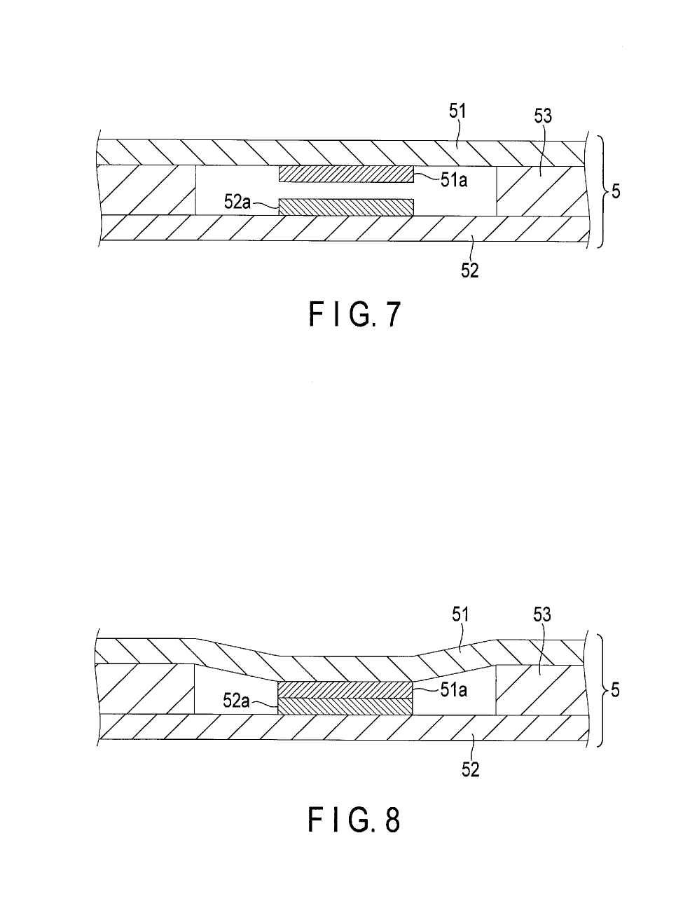

FIGS. 6 to 8 show the structures of the membrane switch 5. FIG. 6 is a top plan view, and FIGS. 7 and 8 are sectional views of the contacts. The membrane switch 5 is a sheet-like member having a three-layer structure comprising an upper sheet 51, a lower sheet 52, and a spacer sheet 53 interposed between these sheets 51 and 52. Each of the sheets 51, 52 and 53 is formed of an elastic synthetic resin material. The upper sheet 51 and the lower sheet 52 respectively comprise circuits, and contacts 51a and 52a of the circuits are provided respectively on the surfaces of the sheets facing each other.

FIG. 7 shows the membrane switch 5 in a normal state (where the membrane switch 5 is not under downward pressing force). In the state of FIG. 7, the contacts 51a and 52a are facing but separated from each other by the spacer sheet 53 and kept in open states. Between the membrane switch 5 (more specifically, the upper sheet 51) and the keycap 3, an operation member (not shown) which opens or closes the contacts 51a and 52a by receiving downward pressing force from the descending keycap 3 is provided. The operation member is a dome-like member which is formed of, for example, a rubber material continuously, is elastically deformable along the z-axis, and is provided above the upper sheet 51 in such a manner that the top of the dome is directed to the side of the keycap 3 and aligns with the contacts 51a and 52a.

When the keycap 3 is pressed down (a keystroke is performed) by the operator and then downward pressing force acts on the top of the dome-like operation member via the keycap 3, the operation member elastically deforms and presses the upper sheet 51. At this time, as shown in FIG. 8, the upper sheet 51 elastically deforms toward the lower sheet 52, and then the contact 51a contacts the contact 52a. By contacting the contacts 51a and 52a, the circuits of the upper sheet 51 and the lower sheet 52 can be closed. The lowermost position of the keycap 3 corresponds to the position on the z-axis at which the contacts 51a and 52a contact in this manner. Note that FIG. 8 shows a state where the membrane switch 5 elastically deforms (the membrane switch 5 is under the downward pressing force).

Further, when the keycap 3 is released and the downward pressing force stops acting on the top of the dome-like operation member, the operation member elastically returns to its original shape. As a result, the upper sheet 51 elastically returns to its original shape, the contact 51a separates from the contact 52a, and the membrane switch 5 returns to a state where the contacts 51a and 52a are facing each other with a predetermined gap (state shown in FIG. 7). Further, the keycap 3 is pushed up and returns to its original state (state shown in FIG. 1) by receiving the force from the operation member returning to its original shape. The uppermost position of the keycap 3 corresponds to the position on the z-axis in the state of FIG. 1, that is, in a state where the keycap 3 is not under the restoring force of the operation member.

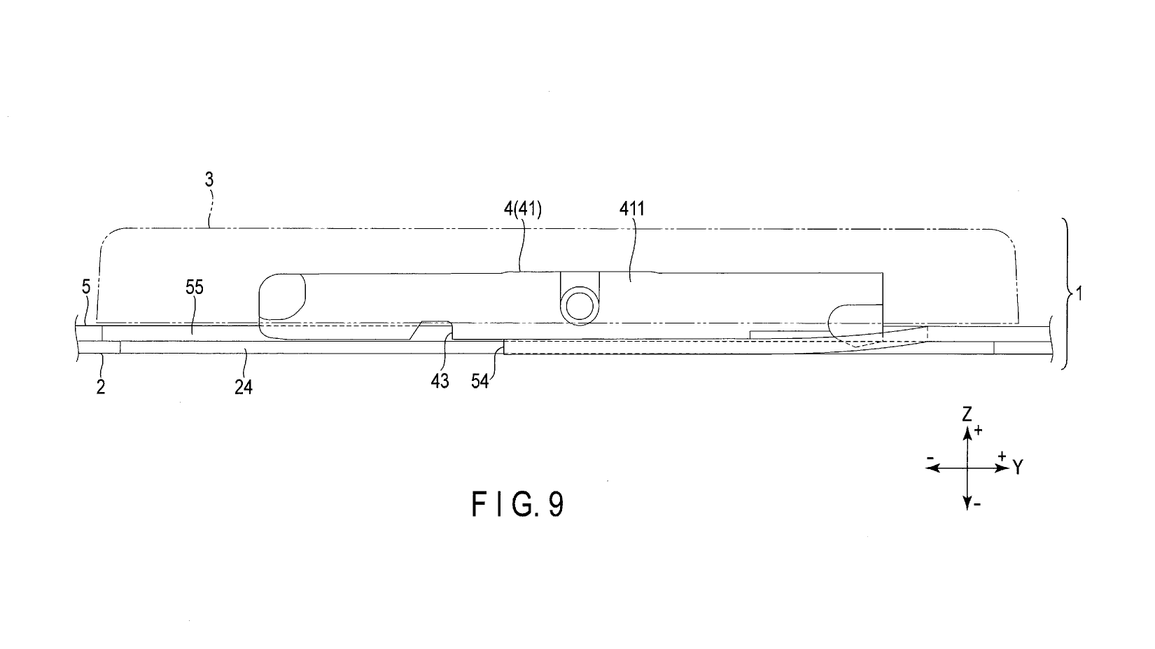

As shown in FIGS. 1 and 9, the first supporting member 41 of the supporting member 4 comprises a projection portion 43 which presses the membrane switch 5 when the keycap 3 descends. FIG. 9 is a diagram briefly showing a state where the keycap 3 is at the lowermost position. The projection portion 43 is not contacting the membrane switch 5 when the keycap 3 is in the uppermost position. On the other hand, the projection portion 43 contacts the membrane switch 5 at a given time when the keycap 3 descends from the uppermost position to the lowermost position, and presses the membrane switch 5. FIG. 1 shows a case where the projection portion 43 is provided in a portion near the attachment hole 415 of the longitudinal arm portion 411 and is projecting downward, as an example. In this case, the projection portions 43 are provided in the pair of arm portions 411, and are projecting downward from the arm portions 411 continuously for predetermined lengths along the y-axis. Note that the aspects of the projection portion 43 such as the size, the position, the projection height and the number are not necessarily restricted to those described above but may be determined appropriately as long as the projection portion 43 contacts (presses) the membrane switch 5.

As shown in FIG. 6, the membrane switch 5 comprises flexible portions 54. When the keycap 3 descends, the flexible portion 54 elastically deforms and bends downward (pressing force direction) as being pressed by the projection portion 43. More specifically, the flexible portion 54 is provided as a part of the upper sheet 51 and the lower sheet 52 of the membrane switch 5. Therefore, when pressed by the projection portion 43, portions in the upper sheet 51 and the lower sheet 52 corresponding to the flexible portion 54 bend downward (pressing force direction). The flexible portions 54 are provided in such a manner as to avoid the circuits of the upper sheet 51 and the lower sheet 52 so that the flexible portions 54 will not affect the conduction of the circuits even when the flexible portions 54 bend in the above-described manner. Note that the spacer sheet 53 may be interposed between the portions in the upper sheet 51 and the lower sheet 52 corresponding to the flexible portion 54. FIG. 6 shows a case where the flexible portion 54 has an area which can be pressed by the whole projection end of the projection portion 43. In this case, the flexible portion 54 having a length slightly greater than that of the projection portion 43 is formed continuously along the y-axis.

The membrane switch 5 comprises a through-hole 55, and the flexible portion 54 bridges over the through-hole 55. In this way, the flexible portion 54 can easily bend downward from the position connecting to the through-hole 55.

The through-hole 55 penetrates trough the upper sheet 51, the lower sheet 52 and the spacer sheet 53 in such a manner as to avoid the circuits of these sheets 51 and 52. FIG. 6 shows a case where the membrane switch 5 comprises four through-holes 55, as an example. These four through-holes 55 correspond to the four projection portions 43 provided respectively in two pairs of the arm portions 411 of the supporting member 4 (first supporting members 41), and are provided on both sides of the longitudinal membrane switch 5 two by two. The flexible portions 54 are provided in such a manner as to bridge over the four through-holes 55 corresponding to the four projection portions 43.

In this case, the through-hole 55 has an area wider than that of the whole projection end of the projection portion 43. In FIG. 6, each of the inner two through-holes 55a of the longitudinal membrane switch 5 has an area wider than an area including the projection portion 43 as well as the projection edges of the supporting member attachment portions 31 and 32, and each of the outer two through-holes 55b of the longitudinal membrane switch 5 has an area wider than an area including the projection portion 43 as well as the projection edges of the supporting member attachment portions 31 and 32 and of the connecting member attachment portions 33. Note that the membrane switch 5 is further provided with a through-hole 56 in addition to the through-holes 55, and that the through-hole 56 has an area wider than that of the projection edge of the connecting member attachment portion 33 provided near the middle portion at the back of the longitudinal keycap 3.

As shown in FIG. 2, the base member 2 comprises an opening portion 24 which the flexible portion 54 pressed and bent by the projection portions 43 enters. The opening portion 24 is formed in such a manner as to partly connect to the through-hole 55. In this way, the flexible portion 54 bridges over the opening portion 24. Therefore, when elastically deforming as being pressed by the projection portion 43, the flexible portion 54 bends toward the opening portion 24 and enters the opening portion 24. FIG. 2 shows a case where the base member 2 comprises four opening portions 24, as an example. These opening portions 24 correspond to the four projection portions 43 provided in the two pairs of arm portions 411 of the supporting member 4 (first supporting members 41), and are provided on both sides of the longitudinal base member 2 two by two.

In this case, the opening portion 24 has an area wider than that of the whole projection end of the projection portion 43. In FIG. 2, each of the two inner opening portions 24a of the longitudinal base member 2 has an area wider than an area including the projection portion 43 as well as the projection edges of the supporting member attachment portions 31 and 32, and each of the two outer opening portions 24b of the longitudinal base member 2 has an area wider than an area including the projection portion 43 as well as the projection edges of the supporting member attachment portions 31 and 31 and of the connecting member attachment portion 33. Note that the base member 2 further comprises opening portions 25 in addition to the opening portions 24. The opening portions 25 are formed in four portions each having an area wider than that of the connecting member attachment portion 33, three of which are formed on the front of the keycap 3 and one of which is formed near the middle portion at the back of the longitudinal keycap 3. Among the four opening portions 25, three opening portions 25a connect to the through-holes 55, and the other one opening portion 25b connects to the through-hole 56.

FIG. 9 shows a state of the projection portion 43 and the flexible portion 54 at the right end when the keycap 3 is at the lowermost position, as an example. As the keycap 3 is pressed down from the uppermost position shown in FIG. 1, the first supporting member 41 and the second supporting member 42 of the supporting member 4 rotate and descend accordingly. Then, at a given time when the keycap 3 descends to the lowermost position, the projection portion 43 of the first supporting member 41 contacts the flexible portion 54 of the membrane switch 5.

After the projection portion 43 contacts the flexible portion 54, the flexible portion 54 is pressed and elastically deformed by the projection 43 until the keycap 3 reaches the lowermost position. At this time, the flexible portion 54 bends downward in the pressing force direction by elastic deformation. The flexible portion 54 is provided in such a manner as to bridge over the opening portion 24 of the base member 2, that is, the opening 24 is provided below the flexible portion 54. With this structure, the flexible portion 54 bending downward enters the opening portion 24 and thus will not contact the upper surface 2a of the base member 2. Therefore, it is possible to absorb the impact of the projection portion 43 on the flexible portion 54 by bending the flexible portion 54. Consequently, a striking sound of the projection portion 43 against the flexible portion 54 can be reduced. Further, since the bent flexible portion 54 does not contact the upper surface 2a of the base member 2, the flexible portion 54 will not make any sound by striking the upper surface 2a.

As described above, according to the key switch 1 of the present embodiment, the striking sound in the keystroke operation can be reduced. As a result, for example, it is possible to achieve more quiet performance of electronic devices. Further, there is no need to provide a buffer sheet or the like in addition to the membrane sheet 5 to realize the reduction of the striking sound. Therefore, it is possible to achieve quiet performance without increasing the total height of the key switch 1.

Note that the supporting member attachment portions 31 and 32 enter the connecting portions of the through-holes 55 of the membrane switch 5 and the opening portions 24 of the base member 2 when the keycap 3 is at the lowermost position. Further, the connecting member attachment portions 33 enter the connecting portions of the through-holes 55 and 56 of the membrane switch 5 and the opening portions 24 and 25 of the base member 2 when the keycap 3 is at the lowermost portion.

Therefore, when the keycap 3 descends from the uppermost position to the lowermost position, the supporting member attachment portions 31 and 32 and the connecting member attachment portions 33 do not contact the membrane switch 5 or the base member 2. Consequently, the supporting member attachment portions 31 and 32 and the connecting member attachment portions 33 will not make any sound by striking the membrane switch 5 or the base member 2.

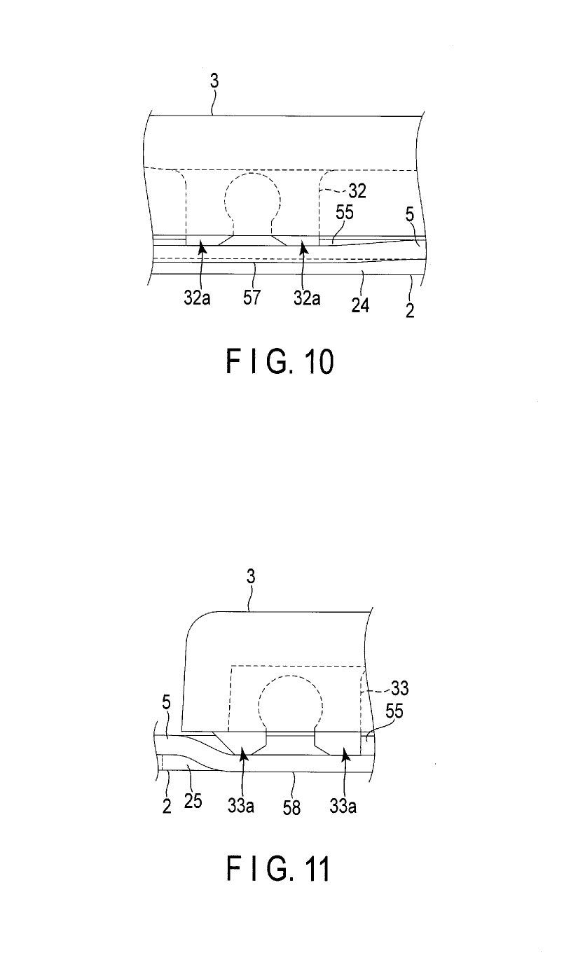

Note that, in addition to or in place of the projection portion 43, it is also possible to provide a projection portion 32a in the supporting member attachment portion 32 in such a manner as to contact a flexible portion 57 of the membrane switch 5 as shown in FIG. 10. In this case, the flexible portion 57 is provided in such a manner as to bridge over the through-hole 55 above the opening portion 24.

Still further, it is also possible to provide a projection portion 33a in the connecting member attachment portion 33 in such a manner as to contact a flexible portion 58 of the membrane switch 5 as shown in FIG. 11. In this case, the flexible portion 58 is provided in such a manner as to bridge over the through-hole 55 above the opening portion 25.

Note that, in the case of providing the projection portion 32a in addition to the projection portion 43 as shown in FIG. 10 or 11, the flexible portion 54 may be omitted and the projection portion 43 may be inserted into the connecting portion of the through-hole 55 and the opening portion 24. In this way, when the keycap 3 descends from the uppermost position to the lowermost position, the projection portion 43 will not contact the membrane switch 5 or the base member 2 and thus will not produce any sound by striking them.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A key switch comprising:
a base member;
a keycap supported by the base member and configured to ascend or descend with respect to the base member;
a supporting member supporting the keycap to the base member so that the keycap ascends or descends with respect to the base member; and
a membrane switch overlaid on the base member and configured to open or close contacts of circuits when the keycap ascends or descends with respect to the base member,
wherein at least one of the keycap and the supporting member comprises a projection portion that presses the membrane switch when the keycap descends with respect to the base member,
the membrane switch comprises a flexible portion that bends when pressed by the projection portion, and
the base member comprises an opening portion that the flexible portion enters when pressed and bent by the projection portion.

2. The key switch of claim 1,
wherein the membrane switch comprises a through-hole, and
the flexible portion bridges over the through-hole.

3. The key switch of claim 1,
wherein the membrane switch comprises an upper sheet, a lower sheet, and a spacer sheet, the upper sheet and the lower sheet comprising the circuits, the spacer sheet interposed between the upper sheet and the lower sheet, and
the flexible portion is provided as a part of the upper sheet and the lower sheet pressed and bent in a pressing force direction by the projection portion.

4. The key switch of claim 1,
wherein the supporting member comprises a first supporting member and a second supporting member that are attached to each other so that the first supporting member and the second supporting member rotate as the keycap ascends or descends with respect to the base member, and
the projection portion is provided in at least one of the first supporting member and the second supporting member.

5. The key switch of claim 1,
wherein the keycap comprises a supporting member attachment portion that connects to the supporting member, and
the projection portion is provided in the supporting member attachment portion.

6. The key switch of claim 1, further comprising a connecting member attached to the keycap and the base member and connecting the keycap and the base member to each other,
wherein the keycap comprises a connecting member attachment portion that connects to the connecting member, and
the projection portion is provided in the connecting member attachment portion.

7. The key switch of claim 1,
wherein the base member is plate-like.

8. The key switch of claim 1,
wherein the membrane switch is sheet-like.
